(19) United States
(12) Patent Application Publication
(10) Pub. No.: US 2006/0186199 A1
(43) Pub. Date: Aug. 24, 2006

(54) Apparatus for authorising access to an electronic device

(76) Inventor: John Parker, Berkshire (GB)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/551,473

(22) PCT Filed: Mar. 31, 2004
(86) PCT No.: PCT/JP04/04582

§ 371 Date: May 4, 2006

(30) Foreign Application Priority Data
Apr. 2, 2003 (GB) 0307628.8

(51) Int. Cl. G06K 5/00

(52) U.S. Cl. 235/382

(57) ABSTRACT

Commonly used mobile devices provide authenticated access to the device through the manual entry of personal identification numbers (PINs). Third generation devices will potentially contain a large amount of user sensitive data and there is a need for increased security on the devices to prevent unauthorised access. However, increasing the number of manually entered PINs or passwords is inconvenient to the user. These problems are overcome providing authorisation to access the electronic device via a series of radio signals between the electronic device and a radio module which is paired to the device. The module is carried separately from the device and, when authorisation is required, the device automatically attempts to detect the presence of the radio module. In order to detect the presence of the module, the device transmits a search signal to the module (130). The radio module receives (140) the search signal from the device and transmits an authorisation signal in response (100). On receiving (170) the authorisation signal the electronic device provides the user with access to the restricted application (185). If the electronic device does not receive an authorisation signal from the module, access to the electronic device is initially refused and the user may be required to provide further authorisation, for example using a PIN, in order to access the restricted application.

### TECHNICAL FIELD

The present invention relates to an apparatus for authorising access to an electronic device.

### BACKGROUND ART

Third generation mobile communication devices provide the facility for users to store a large amount of confidential personal information on the device such as bank account details, personal contact details and calendar, diary entries and other data. Devices are also capable of sending e-mails and transmitting documents and it is probable that confidential e-mails and documents may be stored on the device. Therefore, the contents of the user's device may be confidential and a user will wish to prevent third parties from accessing them.

Mobile phone crime is common and the continued reduction in the size of mobile devices allows them to be easily misplaced or inadvertently left in public places. On losing a device, a user can advise the network that the device has been lost or stolen and the network will prevent that device from making or receiving calls. However, the network is not able to power down the phone. Therefore, the person in possession of the device may still access the features and information which is stored within the device although they are not able to connect to the network.

Generally this is a satisfactory solution for the user. Known devices contain address books and saved text messages, and although the loss of such information may be inconvenient, in general, it is not serious. Therefore, when a device is lost or stolen, most users are more concerned about preventing the use of the device for making calls than the loss of any personal information contained within the device.

In contrast, third generation systems will regularly contain a large amount of confidential personal information. The potential loss of the data stored on the device is likely to be more distressing to the user than the inconvenience of replacing the device. In fact, it is feasible that thieves may target mobile devices for the information stored within them rather than for the physical device itself. Users will require confidential information stored on the device to be secure and non-accessible if the device is lost or stolen.

Commonly used mobile devices provide authenticated access to the device through the manual entry of personal identification numbers (PINs). Typically, on power up the user will be required to enter a security PIN in order to gain access to the device. On entering the correct PIN the device will attach itself to the network and the user may access the features of the device. If the PIN is entered incorrectly access to the device is denied and, in certain cases, entering an incorrect PIN a predefined number of times will cause the device to deactivate. During use, the device may enter sleep mode or the keypad may be activated and deactivated by a combination of key presses, however, typically there is no requirement for further PIN entries and authentication is only required on power up.

Some mobile devices provide the facility for the user to set further PIN security mechanisms to provide access to selected functions of the mobile device. However, further PINs are rarely activated due to the inconvenience of executing the manual authorisation procedure each time the user wishes to use the restricted function.

In third generation systems, the frequency of access is likely to be considerably greater than that of current systems since the user will use the device to access non-call related features, for example e-mails, stored documents or diaries. Therefore, further PIN requirements will be more inconvenient for the user. In this case, users are even more unlikely to activate further PIN security mechanisms. This will leave users more prone to unauthenticated access to sensitive data.

Thus, third generation devices will potentially contain a large amount of user sensitive data and there is a need for increased security on the devices to prevent unauthorised access. However, increasing the number of manually entered PINs or passwords is inconvenient to the user.

### DISCLOSURE OF THE INVENTION

Embodiments of the present invention overcome these problems by providing authorisation to access the electronic device via a series of radio signals between the electronic device and a radio module which is paired to the device. The module is carried separately from the device and, when authorisation is required, the device automatically attempts to detect the presence of the radio module.

In order to detect the presence of the module, the device transmits a search signal to the module. The radio module receives the search signal from the device and transmits an authorisation signal in response. On receiving the authorisation signal the electronic device provides the user with access to the restricted application. If the electronic device does not receive an authorisation signal from the module, access to the electronic device is initially refused and the user may be required to provide further authorisation, for example using a PIN, in order to access the restricted application.

The invention is defined more precisely in its various aspects in the appended claims to which reference should now be made.

### BRIEF DESCRIPTION OF THE DRAWINGS

Embodiments of the present invention will now be described in detail by way of example with reference to the accompanying drawings, in which:

FIG. 1 is a flow diagram showing the authentication procedure between an electronic device and a paired radio module;

FIG. 2 shows the communication link between the electronic device and a radio module;

FIG. 3 is a flow diagram showing the procedure for executing a manual authorisation check;

FIG. 4 is a flow diagram showing the procedure for obtaining access to the device in a preferred embodiment of the device;

FIG. 5 is a block diagram showing an example of the configuration of the electronic device; and

FIG. 6 is a block diagram showing an example of the configuration of the radio module.

### BEST MODE FOR CARRYING OUT THE INVENTION

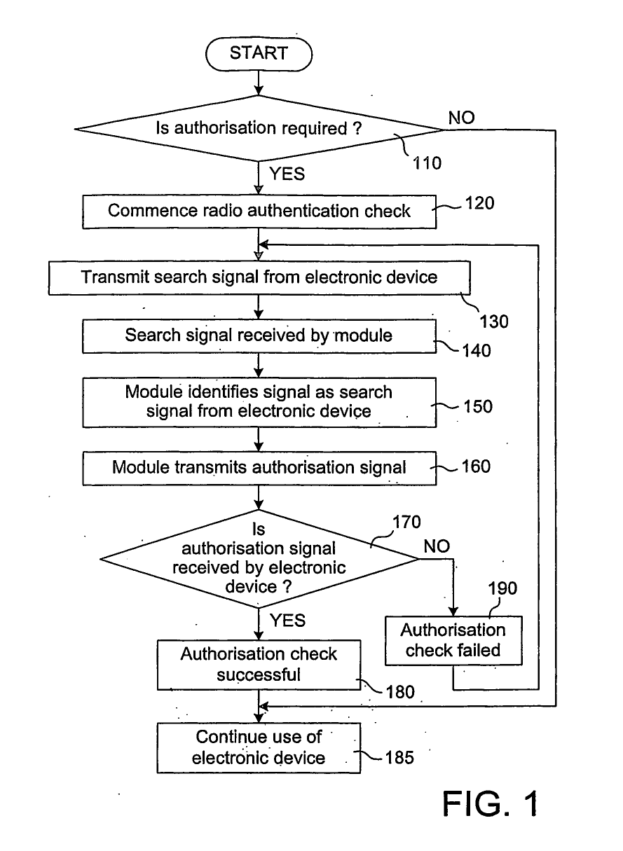

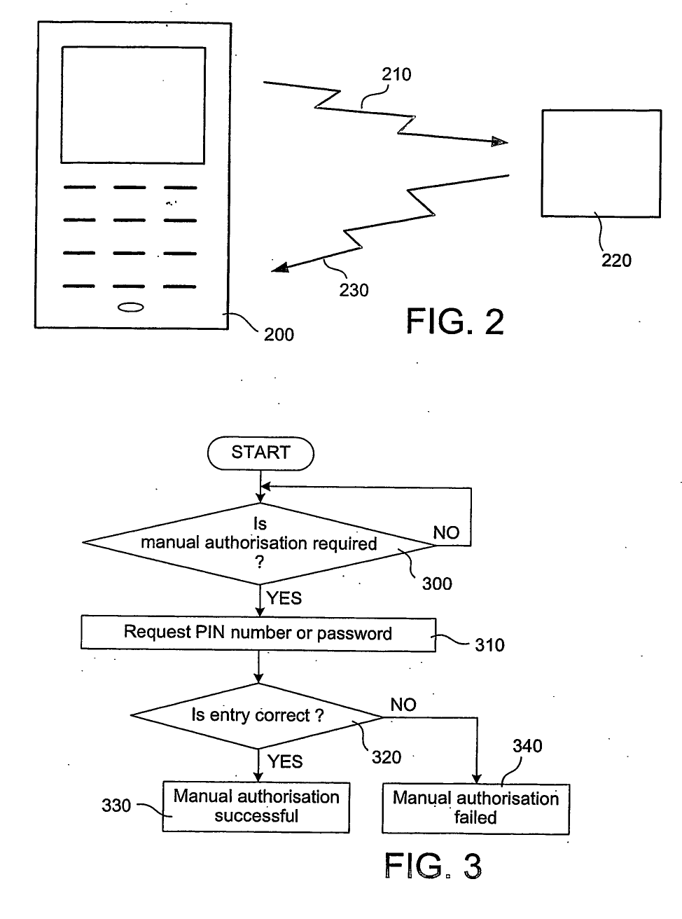

FIGS. 1 and 2 show the authentication procedure between the electronic device 200 and the radio module 220. At box 110 the device 200 determines whether authorisation is required. If the application is not required, the user may continue use of the device. However, if authorisation is required then the device 200 will commence an authorisation check with a paired radio module 220 at box 120.

The device 200 executes the authorisation check by transmitting a search signal 210 to a paired module 220 at box 130. The module 220 receives the search signal 210 at box 140 and identifies whether the signal was transmitted by the electronic device 200 at box 150. Typically the electronic device 200 will transmit signals on a specific frequency, however, further embodiments of the invention may include other means of identifying that the signal is a search signal 210. If the signal is identified as a search signal 210 at box 150, the module 220 transmits an authorisation signal 230 in response at box 160. If at box 170 the electronic device 200 receives the authorisation signal 230 from the module 220, the authorisation is successful at box 180, and the user continues use of the device at box 185.

If the device 200 does not receive the authorisation signal 230 at 170, then the authorisation check has failed at box 190. Typically a predetermined time period is set within which the device 200 expects to receive an authorisation signal 230. This time period is typically fractions of a second and will not be perceived by the user. If the authorisation signal 230 is not received within this period then the authorisation check has failed. If the authorisation check has failed at box 190, certain embodiments of the invention may re-execute an authorisation check by transmitting a further search signal 210 at box 130.

In preferred embodiments of the present invention, if the radio authorisation check fails then the device may execute a manual authentication check in order that the user may be provided with a further opportunity to access the device. FIG. 3 shows the procedure for execution of a manual authentication procedure. At box 300 the device 200 determines whether manual authorisation is required. If manual authorisation is required then the device requests manual authorisation at box 310. Typically the device will require a PIN number or password which is entered via the keypad, however further embodiments may include audio passwords or other authorisation codes. If the entry is correct at box 320 then the manual authorisation is successful at box 330. However, if an incorrect PIN is provided at 320 then access to the manual authorisation has failed at box 340. Embodiments of the invention may then re-execute the manual authorisation check at box 310 for a predetermined number of times. In certain embodiments, if the user makes a predefined number of incorrect entries, the device will automatically shut down.

The radio authentication procedure may be used to restrict access to applications, files or functions of the device. Restricted applications may include areas of memory, files or software run applications on the electronic device. Furthermore, the making or receiving of calls may be restricted. Preferred embodiments can be con figured by a user and the user can designate that any application of the device requires authentication before access to that application is permitted. In other embodiments, the device will automatically designate that access to applications is restricted. For example, the user may select that a restriction be included at power up of the device and therefore each time the device is powered up the user will not be allowed to proceed to use the device until authorisation is provided.

Apparatus for executing a radio authorisation procedure may be incorporated into any electronic device. Furthermore, the times at which the authorisation procedure is executed and the events which trigger the execution of the procedure will vary in the many possible embodiments of the invention. A few preferred embodiments are now described, however this list is not exhaustive.

In a first preferred embodiment a radio authorisation check is made on power up of an electronic device and subsequently at each time a new application is selected. If the radio authorisation check is successful then access to that application is permitted. If radio authorisation is not successful then the device will require manual authorisation in order that the user may be permitted access to the application.

Once the user has successfully gained access to a particular application, no further radio or manual authorisation checks are executed for that application while the device remains powered up. However, once the device is powered down, the authorisation status of the device is reset and an authorisation check will be executed again after power up. In this embodiment, authorisation may be required for all application or only selected applications. The selected applications may be determined by the user, or automatically by the device.

In a second preferred embodiment the device executes a radio authorisation check when the unit is powered up. If the radio authorisation is successful, the user is permitted use of the device. If the radio authorisation check fails after power up, the user is required to enter a manual authorisation in order to proceed with use of the device.

Once access to the device has been obtained the device may perform further radio authorisation checks either at regular time intervals and/or on selection of a secure application. The time periods at which the authorisation checks are executed and applications which are secure may be determined by the user or configured during production.

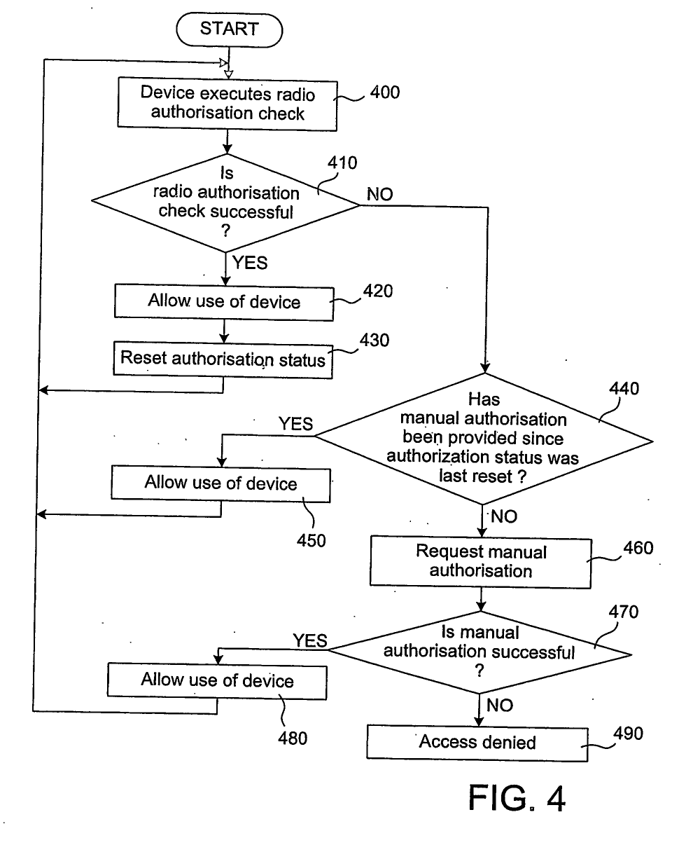

The procedure following a radio authorisation check is shown in the flow diagram of FIG. 4. At box 400 the device executes a radio authorisation check. If the check is successful at box 410 use of the device is permitted at box 420. The authorisation history is then deleted from the memory of the device and the authorisation status of the device is reset at box 430.

If the radio authorisation check is unsuccessful at box 410 the device determines, at box 440, whether correct manual authorisation has been provided since the last reset of the authorisation status. If manual authorisation has been provided since the last reset then use of the device is permitted at box 450. However, if manual authorisation has not been provided then manual authorisation is requested at box 460. If the manual authorisation is correctly entered at box 470, access is provided at box 480. If manual authorisation is not correctly entered at 470 then access is denied at box 490.

Therefore, in the situation when a user powers up his mobile telephone out of the range of the radio module he will be prompted for manual authorisation in order to gain access to the device. If the user correctly provides the manual authorisation he is permitted use of the device. Once the device returns to within the range of the module and the device executes a successful radio authorisation, the authorisation status of the device will be reset. The user will be prompted to enter manual authorisation on the next occasion when the radio authorisation check is unsuccessful. In this embodiment, if the device is stolen or misplaced while in the range of the radio module then subsequent use of the device outside the range of the module is not permitted until correct manual authorisation has been provided.

In a third preferred embodiment a radio authorisation check is executed on power up. If the check is successful then access is permitted to the unit, however if the check is unsuccessful then the user must provide correct manual authorisation in order to gain access to the device. Once access is obtained, the user is provided with use of the device. However, the unit includes a timer to determine the time period for which the device is idle. When the device is idle for a time period exceeding a predefined time period the authorisation status of the device is reset and the next time a key is depressed a radio authorisation check is made.

Further embodiments execute radio authorisation checks each time an application is selected or periodic authorisation checks in order to provide continued use of the device.

Embodiments of the present invention allow a user to restrict access to certain applications within a mobile communications device. Authentication is provided by an exchange of signals between the device and a radio module which is paired to the device. The authorisation is provided automatically and the user is not required to enter any passwords unless the device is out of range of the module. In fact, if the radio authorisation check is successful, the user will be unaware that an authorisation check has been made. The invention provides a user with secure applications within his electronic device and, as long as the device is in the vicinity of the module, the user will not have the inconvenience of manually providing authorisation to access the secure application.

The increasingly widespread use of radio hands free sets, in particular devices incorporating e.g. Bluetooth technology, enables a separate device to be carried which is distinct from the device. The hands free device is unlikely to be lost or stolen with the device and therefore, any unauthorised user will not remain in the range of the radio device. The user may be provided with a small radio device which is dedicated to use with the invention or the module may be incorporated any radio device which the user carries on his person. Such a device could be kept in a user's wallet or purse or on a key-ring.

Embodiments of the invention also provide users with different levels of security for applications. For example, a user may designate that certain applications can only be accessed in the presence of a first module. More sensitive applications might only be accessible in the presence of a second module. The user may also have the option of not allowing access at all if the required module is not present and therefore any radio authorisation checks are unsuccessful.

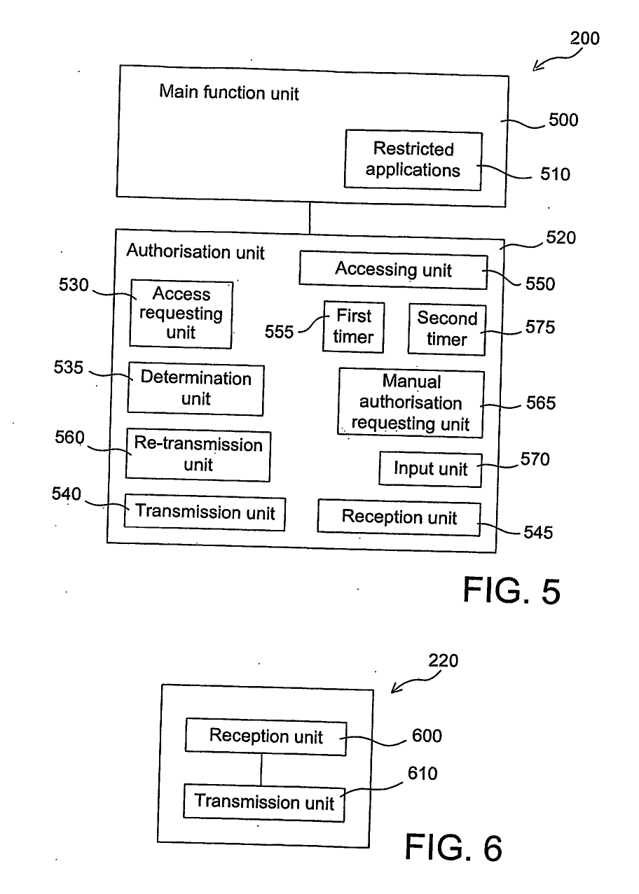

An example of the electronic device according to the present invention is illustrated in FIG. 5. The illustrated electronic device 200 generally consists of a main function unit 500 and authorisation unit 520. The main function unit 500 includes restricted applications 510 to which the user wish to access. The authorisation unit 520 has a access requesting unit 530 for requesting access to the electronic device, a determination unit 535 for determining that authorisation is required in order that access be provided, a transmission unit 540 for transmitting a search signal upon determination that authorisation is required, a reception unit 545 for receiving an authorisation signal, and an accessing unit 550 for providing access to the electronic device in dependence on the received authorisation signal. Typically, the search signal and authorisation signal are radio signals.

The electronic device may include, in the authorisation unit 520, a first timer 555 for determining a first time period between transmission of the search signal and receipt of the authorisation signal. In this case, access to the electronic device will be provided in dependence on the first time period being less than a first predefined time period. The electronic device may be additionally provided with a re-transmission unit 560 in the authorisation unit 520 to re-transmit the search signal if the authorisation signal is not received within the first predefined time period. The electronic device may be further provided with, in the authorisation unit 520, a manual authorisation requesting unit 565 for requesting manual authorisation to the user if the authorisation signal is not received within the first predefined time period, and an input unit 570 for inputting the manual authorisation such as a personal identification number.

In the electronic device, the determination unit 535 may perform its function on power up of the electronic device and/or periodically after power up of the electronic device. Alternatively, the determination unit 535 may perform its function when access to selected applications on the electronic device is requested.

The electronic device may include, in the authorisation unit 520, a second timer 575 for measuring a second time period for which the electronic device has been idle. The determination unit 535 may perform its function in dependence on the second time period exceeding a second predefined time period. The second predefined time period may be determined by a user.

An example of the radio module according to the present invention is illustrated in FIG. 6. The radio module 220 includes a reception unit 600 for receiving a search signal from the electronic device, and a transmission unit 610 for transmitting an authorisation signal for the electronic device in response to the received search signal. The search signal and authorisation signal are typically radio signals.

It will be obvious to those skilled in the art that the present invention is not restricted to use with mobile phones. The invention can be applied to any electronic device, for example a laptop computer, or personal organiser. Furthermore, the invention can be usefully incorporated into any fixed position electronic device for example a personal computer.

1. An apparatus for providing access to an electronic device comprising:
means for requesting access to the electronic device;
means for determining that authorisation is required in order that access be provided;
means for transmitting a search signal upon determination that authorisation is required;
means for receiving an authorisation signal; and
means for providing access to the electronic device in dependence on the received authorisation signal.

2. An apparatus for providing access to an electronic device according to claim 1, further comprising means for determining a first time period between transmission of the search signal and receipt of the authorisation signal wherein access to the electronic device is provided in dependence on the first time period being less than a first predefined time period.

3. An apparatus for providing access to an electronic device according to claim 2, comprising a means to re-transmit the search signal if the authorisation signal is not received within the first predefined time period.

4. An apparatus for providing access to an electronic device according to claim 2, comprising means for requesting manual authorisation if the authorisation signal is not received within the first predefined time period.

5. An apparatus for providing access to an electronic device according to claim 4, comprising means for inputting manual authorisation.

6. An apparatus for providing access to an electronic device according to claim 5, wherein the manual authorisation is a personal identification number.

7. An apparatus for providing access to an electronic device according to claim 1, wherein the means for determining that authorisation is required performs this function on power up of the electronic device.

8. An apparatus for providing access to an electronic device according to claim 1, wherein the means for determining that authorisation is required performs this function when access to selected applications on the electronic device is requested.

9. An apparatus for providing access to an electronic device according to claim 7, wherein the means for determining that authorisation is required performs this function periodically after power up of the electronic device.

10. An apparatus for providing access to an electronic device according to claim 1, comprising means for measuring a second time period for which the electronic device has been idle.

11. An apparatus for providing access to an electronic device according to claim 10, wherein the means for determining that authorisation is required performs this function in dependence on the second time period exceeding a second predefined time period.

12. An apparatus for providing access to an electronic device according to claim 11, wherein the second predefined time period is determined by a user.

13. An apparatus for providing access to an electronic device according to claim 1, wherein the search signal and authorisation signal are radio signals.

14. An apparatus for providing remote authorisation to access an electronic device comprising:
means for receiving a search signal from the electronic device; and
means for transmitting an authorisation signal for the electronic device in response to the received search signal.

15. An apparatus for providing remote authorisation to access an electronic device according to claim 14, wherein the search signal and authorisation signal are radio signals.

16. A method for providing access to an electronic device comprising the steps of:
requesting access to the electronic device;
determining that authorisation is required in order that access be provided;
transmitting a search signal upon determining that authorisation is required;
receiving an authorisation signal; and
providing access to the electronic device in dependence on the received authorisation signal.

17. A method for providing access to an electronic device according to claim 16, including the further step of comparing a first time period between the transmission of the search signal and the receipt of the authorisation signal with a first predefined time period and providing access to the electronic device in dependence on the time period being less than the first predefined time period.

18. A method for providing access to an electronic device according to claim 17, including the step of re-transmitting the search signal if the authorisation signal is not received within the first predefined time period.

19. A method for providing access to an electronic device according to claim 17, including the step of requesting manual authorisation if the authorisation signal is not received within the first predefined time period.

20. A method for providing access to an electronic device according to claim 19, wherein the manual authorisation is a personal identification number.

21. A method for providing access to an electronic device according to claim 16, wherein the step of determining that authorisation is required is performed on power up of the electronic device.

22. A method for providing access to an electronic device according to claim 16, wherein the step of determining that authorisation is required is performed when access to selected applications on the electronic device is requested.

23. A method for providing access to an electronic device according to claim 22, wherein the step of determining that authorisation is required is performed periodically after power up of the electronic device.

24. A method for providing access to an electronic device according to claim 16, including the step of measuring a second time period for which the electronic device has been idle.

25. A method for providing access to an electronic device according to claim 24, wherein the step of determining that authorisation is required is performed in dependence on the second time period exceeding a second predefined time period.

26. A method for providing access to an electronic device according to claim 25, wherein the second predefined time period is determined by the user.

27. A method for providing access to an electronic device according to claim 16, wherein the search signals and authorisation signals are radio signals.

28. A method for providing remote authorisation to access to an electronic device comprising the steps of:
receiving a search signal; and
transmitting an authorisation signal for the electronic device in response to the received search signal.

29. A method for providing remote authorisation to access an electronic device according to claim 28, wherein the search signal and authorisation signal are radio signals.

30. A system for authorising access to an electronic device comprising:
an electronic device; and an electronic module,
wherein the electronic device comprises
means for requesting access to the electronic device,
means for determining that authorisation is required in order that access be provided,
means for transmitting a search signal upon determination that authorisation is required,
means for receiving an authorisation signal, and
means for providing access to the electronic device in dependence on the received authorisation signal,
and wherein the electronic module comprises
means for receiving a search signal from the electronic device, and
means for transmitting an authorisation signal for the electronic device in response to the received search signal.

31. A method for authorising access to an electronic device including the steps of:
requesting access to the electronic device;
determining that authorisation is required in order to provide access to the electronic device;
transmitting a search signal from the electronic device upon determining that authorisation is required;
receiving the search signal at an electronic module;
transmitting an authorisation signal from the electronic module in response to the received search signal;
receiving the authorisation signal at the electronic device; and
providing access to the electronic device in dependence on the received authorisation signal.
